(19) United States
(12) Patent Application Publication
(10) Pub. No.: US 2007/0029039 A1
(43) Pub. Date: Feb. 8, 2007

(54) Method for taping a strip connection and adhesive tape applicator

(76) Inventor: Andreas Noe, Kerken (DE)

Correspondence Address: WILLIAM COLLARD;COLLARD & ROE, P.C., 1077 NORTHERN BOULEVARD, ROSLYN, NY, 11576, US

(21) Appl. No.: 11/490,320

(22) Filed: Jul. 20, 2006

(30) Foreign Application Priority Data
Aug. 6, 2005 (DE) 10 2005 037 182.5

(51) Int. Cl. B32B 37/12; B32B 37/00; B29C 65/00

(52) U.S. Cl. 156/304.3; 156/267; 156/580

(57) ABSTRACT

A method and an adhesive tape applicator is provided for taping a strip connection of two metal strip ends that have been connected with one another by means of adhesive tape having a predetermined width. The top and the bottom of the strip connection are each covered by an adhesive tape segment. The length of the two adhesive tape segments essentially corresponds to a width of the strip ends and, if the strip width is not the same, to the width of the wider strip end.

### BACKGROUND OF THE INVENTION

1. Field of the Invention

The invention relates to a method for taping a strip connection, particularly a mechanical strip connection, which comprises two strip ends, particularly metal strip ends, that have been connected with one another with adhesive tape having a predetermined width.

2. The Prior Art

In strip processing lines, strips that have been wound up into coils are unwound in the intake part, then pass through various processing stations, and are wound up again in the exit part. So that the strips do not constantly have to be newly threaded in, the strip beginning of a new coil is connected with the strip end of the last coil. Common methods for connecting the strip ends, in the case of metal strips, are punched connections (stitching), welded connections, but also glued connections, as is the case for other strips.

In the case of punched connections, the strip ends are placed overlapping one another, and passed to a punching press. The punching press has an upper and a lower punching tool. Both punching tools are generally configured in such a manner that a punched pattern is produced through both ends during a punch stroke. After punching, the punched patterns are hooked into one another, and strip tension is produced by means of a wind-up or unwind windlass. Afterwards, the punched connection is suitable for reliable passage through the strip processing line. In the exit part, the strips that have been connected with one another in this manner are separated again, and the punched connection is cut out.

Such punched connections are regularly used in the case of metal strips having a thickness range of approximately 0.1 to 5 mm. This applies, in particular, for alloyed metal strips that are difficult to weld or cannot be welded at all, and in which a glued connection is not sufficiently reliable. This holds true, for example, for strip coating lines with drying ovens, annealing lines with annealing ovens, or also if the required strip tension exceeds the strength of a glued connection.

In the case of punched connections, burrs caused by the cutting gap of the two punching tools or chip particles that are loose or are still slightly connected with the strip can be produced. While the strips pass through a strip processing line and run around processing line rollers in this connection, burrs or chip particles can break off and remain adhering to the processing line rollers, particularly if these rollers are plastic-coated. There is then the risk that the burrs or chip particles produce an impression on the strip surface during every roller revolution, and consequently produce unacceptable product defects. In order to prevent this, a temperature-resistant adhesive tape can be wrapped around punched connections, manually or by machine. The beginning of the adhesive tape is pressed onto a spot of the strip connection, the adhesive tape is unwound from a roll of adhesive tape, the strip connection is wrapped, and finally, the adhesive tape is cut through, to separate it from the adhesive tape roll. The width of the taping is selected so that the two strip ends are both covered with tape, so that no burrs or particles can exit and adhere to processing line rollers. In the case of two strip ends having different strip width, it is necessary to first remove the protruding strip corners by means of lateral punching (notching), since otherwise, the strip corners could bend around when they are taped, particularly if relatively thin metal strips are involved.

A significant disadvantage of wrapping strip connections with adhesive tape can be seen in the time that is required for this. Depending on the strip width, this can take approximately 30 to 45 seconds in the case of strip wrapping by machine, and approximately 2 to 3 minutes in the case of manual strip wrapping. In a continuous strip processing line, the coil changing time is bridged with a strip storage unit in the intake part, so that the strip can continue to run in the strip processing line during the coil change on the intake side. The wrapping time must be added to the coil changing time. This means that the strip storage unit must be configured to be significantly larger. In the case of strip processing lines with a strip storage unit that already exists and is coordinated with the coil change, retrofitting for wrapping strip connections is therefore not possible.

### SUMMARY OF THE INVENTION

The invention is based on the task of creating a method of the embodiment described initially, according to which taping of strip connections can be carried out in a particularly time-saving manner. Furthermore, an adhesive tape applicator is created which has a particularly simple and functionally practical method of construction, which guarantees quick taping of strip connections.

This task is accomplished according to the invention by a method for taping a strip connection, where the top and the bottom of the strip connection are each covered by an adhesive tape segment, and the length of the two adhesive tape segments essentially corresponds to the width of the strip ends, and if the strip width is not the same, to the width of the wide strip end.

These measures have the result that now, time-consuming wrapping of the strip connection with adhesive tape is no longer necessary, and instead, merely two adhesive tape segments are pressed onto the top and bottom of the strip connection in question. This can take place manually and by machine, and occurs in a relatively short time of a few seconds, in any case. This is because according to the invention, the adhesive tape segments can be pressed onto the top and the bottom of the strip connection, for example by an adhesive tape applicator having pressing bars that lie opposite one another. The time for taping the strip connection in question is determined, within the scope of the invention, practically only by the closing and subsequent opening of the pressing bars, and amounts to only 3 to 4 seconds, for example.

For this reason, the method according to the invention allows cost-effective retrofitting of a taping unit for strip connections, even in existing strip processing lines, with the use of such a tape applicator.

Other characteristics that are essential to the invention are listed in the following. Thus, the adhesive tape segments can be fixed in place on the pressing bars, for the taping process, by vacuum application and/or a slightly adhesive back and/or by means of relatively short adhesive strips on the end side. In the case of a slightly adhesive back of the adhesive tape segments, it is ensured that the adhering adhesive tape side, which faces away from the pressing bar, faces the strip connection and adheres so strongly during the course of being pressed onto the strip connection, that the slightly adhesive back comes loose from the pressing bar in question. If the work is carried out with vacuum application and/or adhesive strips for fixing the adhesive tape segments in place, these are fixed in place on the pressing bars with their non-adhering side.

Furthermore, there is the possibility of cycling the strip connection forward into a lateral punching unit after taping, and to trim it laterally there, if this becomes necessary in the case of different strip widths of the two strip ends, or because the strip ends do not lie completely flush on top of one another. In this case, the strip connection is then punched out on both sides, so that no protruding corners cause a disruption during passage of the strip through the strip processing line. In this connection, any protruding adhesive tape pieces that might exist are also cut off. If the strip connection is a punched connection, there are small gaps between the punchings, considered over the strip width. For this case, the invention provides that the lateral trimming of a strip connection configured as a punched connection is carried out between these punchings. For this purpose, the side punch can be adjusted to a corresponding punch width. In this manner, the cutting of punchings is avoided, something that could lead to roller damage.

An object of the invention is also an adhesive tape applicator for implementing the method, which is characterized by a particularly simple and functionally practical method of construction. This adhesive tape applicator comprises two pressing bars for temporary fixation of adhesive tape segments. Either both pressing bars can be moved relative to the strip connection to be taped, or at least one of the two pressing bars can be moved relative to the strip connection that lies on the other pressing bar or rests against it. The adhesive tape applicator has an upper and a lower pressing bar, if the one or two pressing bars can be moved in the vertical direction relative to the strip connection to be taped. This is regularly the case for strip processing lines with strips that pass through them. However, an adhesive tape applicator with horizontally movable pressing bars is also possible within the scope of the invention. The pressing bars preferably have a resilient, e.g. elastic surface, for example made of polyurethane, and are moved together and pressed onto one another for taping a strip connection. As a result, the two adhesive tape segments come loose from the pressing bars and remain adhering to the strip connection. Subsequently, the adhesive tape applicator opens, so that the strip can then be transported through the strip processing line. Preferably, the pressing bars can be moved out of and into the adhesive tape applicator from the side, for the purpose of applying adhesive tape segments. Thus, the pressing bars are pushed, i.e. moved out of the adhesive tape applicator laterally during the time between two coil changes, on guide tracks on the operating side, for example by means of pneumatic or hydraulic cylinders, but a rack and pinion gear is also possible. Afterwards, new adhesive tape segments can be applied to the pressing bars outside of the strip processing line, specifically either manually or by machine. Preferably, at least the upper pressing bar can be pivoted or rotated about its longitudinal axis by 180° in the moved-out state, so that the adhesive tape segments can be applied from the top. After the pressing bars have been fitted with adhesive tape segments once again, they are moved back, i.e. pulled back into the adhesive tape applicator. The adhesive tape applicator is then ready for taping the next strip connection.

The adhesive tape applicator could also be moved synchronously with the strip velocity, for example on a displacement sled, in the strip running direction, during the taping process, and brought back into its starting position after the taping process, in order to be able to use the adhesive tape applicator with a strip that is running through and consequently moving. Instead of two vertically approaching pressing bars, it is also possible to configure only one of the pressing bars, for example the upper pressing bar, to be vertically approaching, and the other, lower pressing bar to be fixed in location, or vice versa. In this case, the connected strips can be lifted off the pressing bar that is fixed in location, by way of processing line rollers that can be made to approach, for example to be adjustable in height, i.e., they are raised for normal strip running.

Within the scope of the invention, any desired strip connections can be taped, regardless of whether a punched connection, a welded connection, or the like is involved. In the latter case, spatters caused by the welding process must be expected, for example, which could also come loose from the strip surface during strip passage through the strip processing line and adhere to processing line rollers. Self-adhesive connections can be additionally taped.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a strip connection in the embodiment of a punched connection of two strip ends having different widths, in a top view;

FIG. 2 shows the embodiment of FIG. 1 in a side view;

FIG. 3 shows the embodiment of FIG. 1 after it has been taped on the top and the bottom with adhesive tape segments;

FIG. 4 shows a side view of the embodiment of FIG. 3;

FIG. 5 shows the embodiment of FIG. 3 with lateral punch-outs in the region of the strip connection;

FIG. 6 shows an adhesive tape applicator in a schematic side view; and

FIG. 7 shows the object according to FIG. 6, in a detail, in the region of a pressing bar that has been moved out laterally, in a front view.

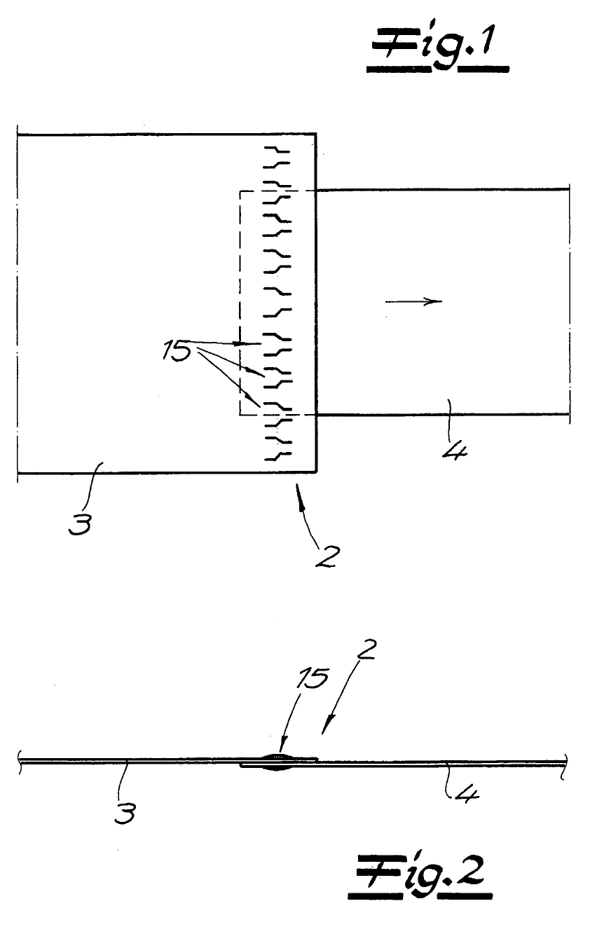

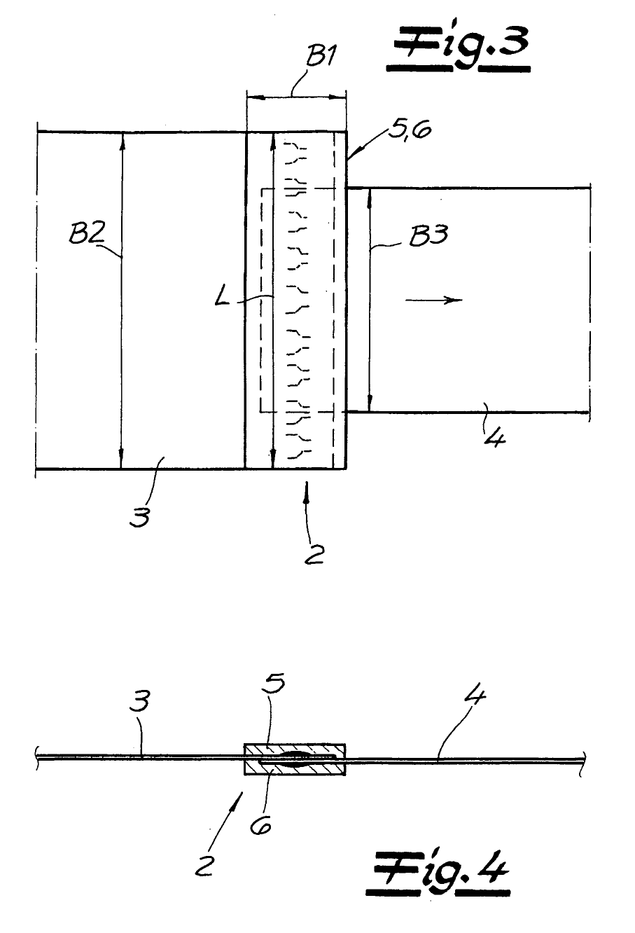

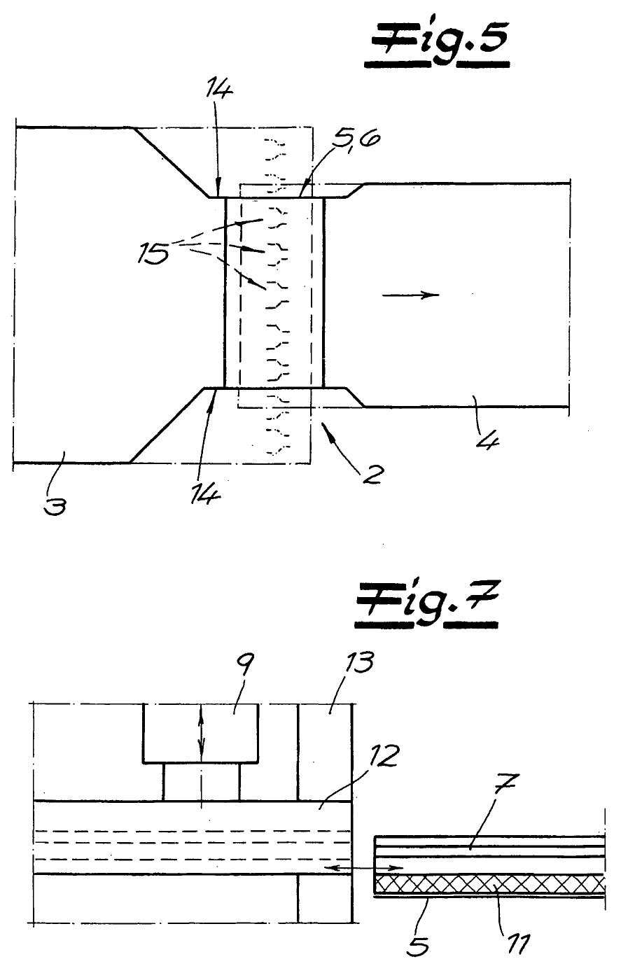

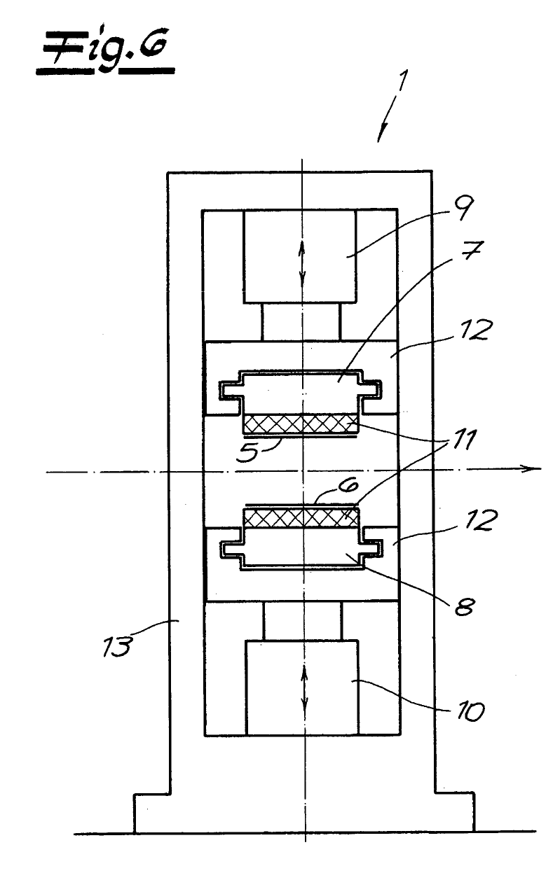

### DETAILED DESCRIPTION OF THE PREFERRED EMBODIMENT

The Figures show an adhesive tape applicator 1 for taping a strip connection 2, particularly a mechanical strip connection such as a punched connection or welded connection of two strip ends 3, 4, particularly metal strip ends, that have been connected with one another by means of adhesive tape having a predetermined width B1. The top and bottom of strip connection 2 are each covered by an adhesive tape segment 5, 6. The length L of the two adhesive tape segments 5, 6 essentially corresponds to the width B2, B3 of strip ends 3, 4, or, in the embodiment shown, to width B2 of the wider strip end 3. Adhesive tape applicator 1 has two pressing bars 7, 8 for temporary fixation of such adhesive tape segments 5, 6. Pressing bars 7, 8 can be moved relative to the strip connection 2 to be taped. Pressing bars 7, 8 can be moved in the vertical direction relative to strip connection 2 to be taped, specifically by means of pneumatic or hydraulic cylinder arrangements 9, 10. Pressing bars 7, 8 have a resilient, e.g. elastic surface 11 made of plastic such as polyurethane, and can be moved laterally out of and into adhesive tape applicator 1, for applying adhesive tape segments 5, 6. At least upper pressing bar 7 can be pivoted or rotated about its longitudinal axis by 180° in the moved-out state, so that adhesive tape segments 5 can be applied from the top.

Pressing bars 7, 8 are guided to move out and in on guide sleds 12, laterally and consequently crosswise to the strip running direction. Sleds 12 in turn are guided in what is essentially a press frame 13, in the vertical direction, and can be moved up with pressing bars 7, 8, and down, relative to the strip that is passing through, i.e. strip connection 2, in each instance, by means of pneumatic or hydraulic cylinder arrangements 9, 10. Adhesive tape segments 5, 6 can be temporarily fixed in place on pressing bars 7, 8 for the taping process, by vacuum application by way of pressing bars 7, 8 and/or a slightly adhesive back and/or by means of adhesive strips on the end sides, not shown. In the case of a strip connection 2 with strips of unequal width, this strip connection is cycled forward into a lateral punching unit after taping, and trimmed laterally, so that punch-outs 14 are formed. The lateral trimming of a strip connection shown as a punched connection 2 is carried out between punchings 15.

Accordingly, while only a few embodiments of the present invention have been shown and described, it is obvious that many changes and modifications may be made thereunto without departing from the spirit and scope of the invention.

What is claimed is:

1. A method for taping a strip connection made of two strip ends that have been connected with one another, comprising:
covering each of a top and a bottom of the strip connection with an adhesive tape segment, wherein a length of the two adhesive tape segments corresponds to a width of the strip ends when the strip ends have a same width, and when the strip end widths are not the same, to a width of a wider of the two strip ends.

2. A method according to claim 1, wherein the adhesive tape segments are pressed onto the top and bottom of the strip connection by an adhesive tape applicator having pressing bars that lie opposite one another.

3. A method according to claim 2, wherein the adhesive tape segments are temporarily fixed in place on the pressing bars with a non-adhesive side of said tape segments.

4. A method according to claim 3, wherein the adhesive tape segments are temporarily fixed in place on the pressing bars by means of vacuum application or a slightly adhesive back or adhesive strips on end sides of the tape segments.

5. A method according to claim 1, wherein the strip connection is cycled forward into a lateral punching unit after taping, and trimmed laterally.

6. A method according to claim 5, wherein the lateral trimming is carried out between punchings created by the lateral punching unit.

7. An adhesive tape applicator for taping a strip connection made from two strip ends, comprising:
two pressing bars for temporary fixation of adhesive tape segments on the strip ends, at least one of said pressing bars being movable relative to the strip connection to be taped.

8. An adhesive tape applicator according to claim 7, wherein said at least one pressing bar is movable in a vertical direction relative to the strip connection to be taped.

9. An adhesive tape applicator according to claim 7, wherein the pressing bars have a resilient, elastic surface.

10. An adhesive tape applicator according to claim 7, wherein said at least one pressing bar is movable laterally out of and into the adhesive tape applicator, for applying the adhesive tape segments.

11. An adhesive tape applicator according to claim 10, wherein at least an upper one of the pressing bars can be pivoted about a longitudinal axis by 180° in a moved-out state.

12. An adhesive tape applicator according to claim 1, wherein the adhesive tape applicator is movable synchronously with a strip velocity during a taping process, and can be brought back to its starting position after the taping process.
